(19) United States
(12) Patent Application Publication
(10) Pub. No.: US 2002/0185086 A1
(43) Pub. Date: Dec. 12, 2002

(54) Method of and system for fuel supply for an internal combustion engine

(76) Inventors: Paul Newman, Calgary (CA); Dale Ulan, Calgary (CA)

Correspondence Address: ILYA ZBOROVSKY, ELY ZBOROVSKY PATENT BUREAU, 6 SCHOOLHOUSE WAY, DIX HILLS, NY, 11746, US

(21) Appl. No.: 09/848,306

(22) Filed: May 4, 2001

(51) Int. Cl. F02B 43/00

(52) U.S. Cl. 123/1 A; 123/672; 123/527; 123/576; 123/577; 123/578

(57) ABSTRACT

A fuel supply for an internal combustion engine includes providing a source of a first fluid fuel and a source of a second fluid fuel which are separate from one another, sensing at least one operational parameter of an internal combustion engine, supplying the first fuel from the one source and the second fuel from the other source in quantities which are determined in correspondence with the sensed operational parameter of the internal combustion engine, and mixing the first fuel and the second fuel in with the quantities determined in correspondence with the sensed operational parameter so as to produce a fuel mixture to be supplied to the internal combustion engine.

### BACKGROUND OF THE INVENTION

The present invention relates to a method of and system for fuel supply for an internal combustion engine.

It is known that the use of natural gas as an engine fuel source has been recognized to have many advantages. Natural gas is a clean burning fuel that lowers overall tailpipe emissions. It may also be used as a fuel without the addition of the additives in gasoline, which often includes chemicals harmful to human health. It is well known that lean engine operation produces relative improvements in the level of exhaust emissions and engine efficiency but problems arise when the lean burn approach is taken with natural gas. These problems include excessive cyclic variations and increased emissions, associated mainly with the narrow operational mixture limits and low flame propagation rates.

Hydrogen is sometimes viewed as being the most attractive of all alternative fuels for the future and is well known to be cleaner burning than natural gas. Its uses as an engine fuel source has a number of attractive features and may moderate the impact of some of the problems associated with using many other gaseous fuels, such as natural gas. The wider operational mixture limits and faster flame propagation rates of hydrogen-air mixtures permit very fuel-lean operation. However, hydrogen engines of current design have their operational problems as well, such as engine knock, backfiring and NOₓ emissions.

Clearly, hydrogen and natural gas behave very differently when used by themselves in an engine. However, it is possible that by mixing these two gaseous fuels and by controlling their respective concentrations in the overall mixture, much of the positive features of hydrogen and natural gas operation can be maintained while minimizing the negative effects of using such fuels on their own. For example, because of the wider operational mixture limits and faster flame propagation rates of hydrogen-air mixtures, the use of hydrogen as an additive can enable a natural gas engine to operate at leaner conditions. Consequently, such lean operation can result in higher thermal efficiencies and lower emissions. Conversely, the presence of natural gas can temper the rapid rates of pressure and temperature rise associated with hydrogen operation thus reducing the possibility of backfire, engine knock and NOₓ emissions.

To date, most commercially viable technology for the utilization of hydrogen and natural gas mixtures, or any mixture of two or more fuel-gas components, are pre-mixed, static systems that deliver the individual fuel component in constant proportions to one another. Such static systems are incapable of meeting the power, or fuel efficiency expected by drivers or the exhaust emission levels now legislated by many environmental regulatory authorities.

### SUMMARY OF THE INVENTION

Accordingly, it is an object of the present invention to provide a method of and system for fuel supply for an internal combustion engine, which avoids the disadvantages of the prior art.

In keeping with these objects and with others which will become apparent hereinafter, one feature of the present invention resides, briefly stated, in a method of fuel supply for an internal combustion engine, which includes the steps of providing a first source of a first fluid fuel and a second source of a second fluid fuel which are separate from one another; monitoring at least one operational parameter of an internal combustion engine; supplying the first fluid fuel from the first fluid fuel source and hydrogen from the compressed hydrogen source in quantities which are determined in correspondence with the sensed operational parameter of the internal combustion engine; and mixing the first fluid fuel and the second fluid fuel in quantities determined in correspondence with the operational parameter so as to produce a fuel mixture to be supplied to the internal combustion engine.

In accordance with another feature of the present invention, a system for a fuel supply for a internal combustion engine is proposed which includes a first source of a first fluid fuel and a second source of a second fluid fuel which are separate from one another; means for monitoring at least one operational parameter of an internal combustion engine; means for supplying the first fluid fuel from the first source and the second fluid fuel from the second fluid fuel source in quantities which are determined in correspondence with the sensed operational parameter of the internal combustion engine; and means for mixing the first fluid fuel and the second fluid fuel quantities determined in correspondence with the operational parameter so as to produce a fuel gas-hydrogen mixture to be supplied to the internal combustion engine.

When the method is performed and the system is designed in accordance with the present invention, it is for the first time possible to dynamically alter the respective proportions of the first and second fluid fuels, for example natural gas and hydrogen in a composite fuel mixture in response to the needs of the driver, while maximizing thermal efficiency and minimizing harmful exhaust emissions.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings. dr

### BRIEF DESCRIPTION OF THE DRAWINGS

FIG. 1 is a view schematically showing a specific system for fuel supply of an internal combustion engine in accordance with the present invention, which operates with the use of an inventive method; and

FIG. 2 is a view schematically showing a basic system for fuel supply of an internal combustion engine in accordance with the present invention which operates with the use of an inventive method.

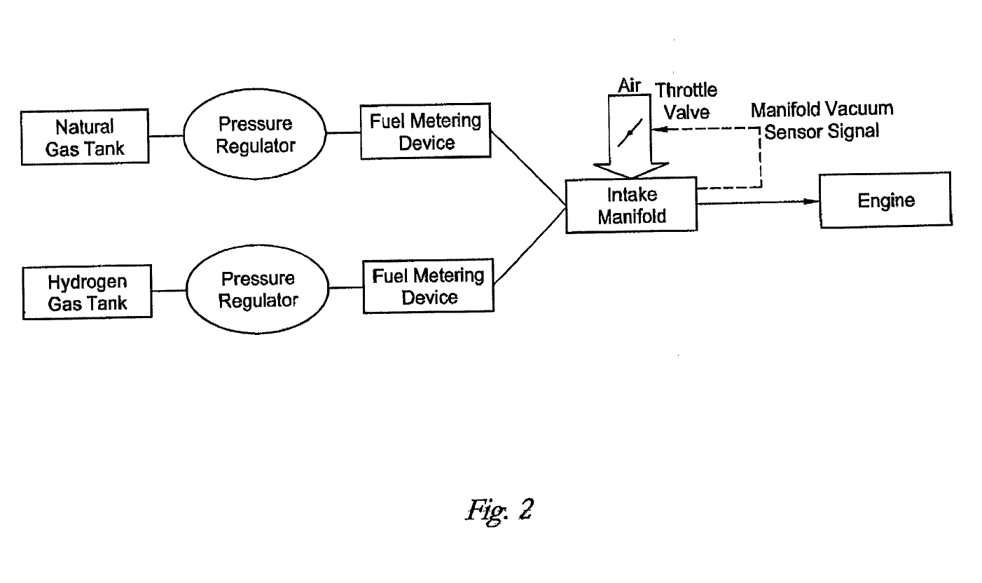

### DESCRIPTION OF THE PREFERRED EMBODIMENTS

A fuel supply system in accordance with the present invention which operates in accordance with the inventive method is used for supplying fuel to an internal combustion engine, for example a spark ignition engine 9. The system includes two high pressure fuel tanks 1 and 2 for storing two fluid fuels such as natural gas and hydrogen. Two control valves or similar metering devices 5 and 6 control supply of the fuels from the gas tanks 1 and 2 to the internal combustion engine. The engine is provided with a spark control module 8 which controls a spark generation by spark plug in each engine cylinder, and an exhaust system 10. In the case of a modern, closed-loop engine, the exhaust system 10 includes an exhaust gas oxygen sensor which outputs an information about oxygen content in the exhaust gases on a signal line. Although it is illustrated as a closed-loop control system, the electronic control unit 13 in accordance with the present invention can be used to operate with engines which are opened-looped and do not have an exhaust gas oxygen sensor.

The engine 9 can be equipped with an intake manifold 7 if the injection of the two fuel gases is to take place within such a device. However, in accordance with the invention, the electronic control unit 13 is equally suited to operate with carbureted engines, or with engines designed to inject the fuel gases near an intake port or directly into the cylinder. The method of fuel delivery into an intake manifold typically employs a traditional fueling strategy called “central injection”. The central injection strategy is a continuous feed approach used to ensure complete mixing of the gaseous fuels and air by delivering a continuous flow of fuel gases into the air stream, which in Otto-cycle engines is not a continuous flow but rather a series of pulses corresponding to the intake stroke of each engine cylinder. It is also possible to deliver fuel to each cylinder with a continuous feed approach. This is called “continuous multipoint injection”.

With the advent of digital fuel injection systems which use “on-off” pulse-width modulation for determining fuel quantity, it became possible to synchronize fuel delivery with air. This ensures that the amount of gaseous fuel delivered to the air charge of each cylinder was correct. The delivery of gaseous fuel to each cylinder timed to the opening of the intake valve is known as “multipoint sequential injection”. Another popular fueling strategy is to simplify this concept by not timing fuel delivery with the individual cylinder, but to have the injectors deliver the gaseous fuels alternately to grouped sets of cylinder every crankshaft revolution. For example the gaseous fuels would be delivered all at once to half of the cylinders in the engine and this half of the engine cylinders would fire simultaneously in one revolution. In the next crankshaft revolution fuel would be delivered to the other half of the cylinders and they would fire simultaneously on that revolution. This would all be timed with the intake valves. This is known as “bank-fire multipoint injection”. The method and system in accordance with the present invention would be equally suited to operate with engines employing any of the above fueling strategies, including those involving carburetion and direct-in-cylinder injection.

The electronic control unit 13 accepts inputs from several sensors, and it outputs control signals to valves 5 and 6, which can be formed as normally closed fuel-gas control solenoid valves. It also outputs control signals to the spark control module 8. During the operation the electronic control unit receives signals from an engine coolant temperature sensor, an intake air temperature sensor, an engine speed sensor, a throttle position sensor, a manifold absolute pressure sensor, fuel pressure sensors, an accelerator pedal position sensor and a battery voltage sensor. For optimal performance it is preferable that the electronic control unit also receives input signals from one or several other sensors such as exhaust gas O₂ sensors, one or several knock sensors, a mass air flow sensor, a barometric sensor, and an exhaust gas recirculation sensor if the engine has exhaust recirculation capabilities. Also, other sensors can be used for sensing other operational parameters.

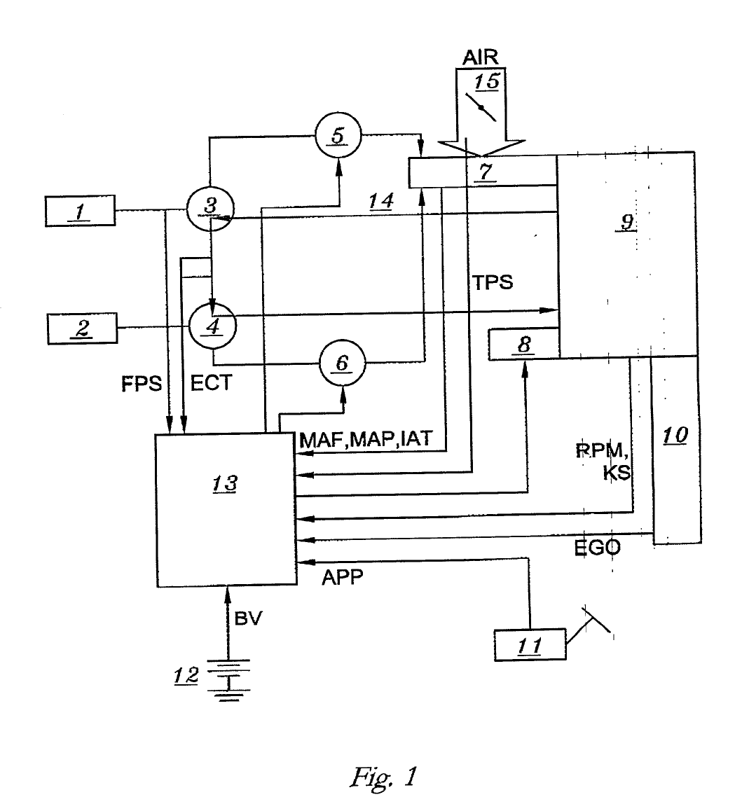

As shown in FIG. 1, the electronic control unit receives a number of input 6 from sensors which monitor selected operating conditions of the engine 9, and in turn sends a signal to the control valves 5 and 6 which supply compressed natural gas and hydrogen with the optional use of pressure regulators 3 and 4. The pressure regulators 3 and 4 provide the fuel supply to the valves 5 and 6 at a constant pressure. The output signal from the electronic control unit 13 to the valves 5 and 6 may be a pulse-width modulation signal over a fuel injection signal line to control the injection of the gaseous fuel. However other types of control methods and other forms of fuel delivery may be utilized.

The duration of opening and the time of opening for the control valves 5 and 6 are determined by a series of computations performed by the electronic control unit 13, using as inputs the signals delivered by the various sensors described above. A technique called “adaptive learning” may continuously monitor these sensor signals and utilize them to control and correct the equivalence ratio of the gaseous fuel-air mixture delivered to the engine 9. This technique can also be made to learn how to accurately control the flow of the fuel and air in order to permit the engine system to function as efficiently as possible, while at the same time to compensate for fuel composition shifts, engine wear, fuel system wear, calibrating shifts or changes in atmospheric conditions. The electronic control unit 13 of the system in accordance with the present invention is equally suited to work with or without adaptive learning techniques.

The utilization of gaseous fuels in a spark ignition engine will invariably involve a power loss at all engine speeds. This problem is exacerbated even further when hydrogen is utilized. Due to the low density of hydrogen, a significant quantity of air will be displaced by hydrogen, even more so than that for natural gas. This displacement results in a reduction in the amount of oxygen available for combustion, and corresponds to approximately 10% power loss compared to natural gas operation. Moreover, since the benefits of hydrogen operation, such as greater thermal efficiencies and lower exhaust emissions are not realized unless the engine operates under very fuel-lean conditions, this will result in a further loss in the power output. Consequently, drivers of naturally aspirated hydrogen vehicles must normally accept power reductions of up to 50%. To overcome this problem, drivers often specify a large engine, or a numerically higher drive axle reduction ratio, or a supercharger, or all of the above, on vehicles scheduled for conversion to hydrogen. While a larger engine offers greater power it is less efficient during idling and low-load conditions and the greater weight of the larger engine will further compromise the benefits of hydrogen operation. A numerically higher driver axle ratio will increase the engine speed for a given road speed, and thus results in lower fuel economy and greater exhaust emissions. A supercharger will compress the intake air which will reduce the amount of air displaced by hydrogen and increase the volumetric efficiency. However, unless the supercharger is designed specifically for the engine platform to be converted to hydrogen, problems of compatibility and reliability of the supercharger may arise.

In order to solve this shortcoming with hydrogen operation, the present invention provides an operating strategy within the electronic control unit 13, which will automatically switch over to predominantly natural gas operation when full engine torque is required. If a driver depresses the accelerator 11 fully, a computer controlled automatic switchover to natural gas occurs which is timed to ensure that there is no period of too much or too little fuel. As soon as the operator begins to release the foot pressure on the accelerator 11, the system automatically switches back to a mixture of natural gas and hydrogen, again with a timer to ensure a seamless transition. This feature is inconspicuous and only noticeable to the driver by the extra torque and optionally by an indicator lamp on the instrument panel. The operating strategy also establishes that during cold starts, idling and low load conditions only hydrogen and no natural gas is consumed. At these conditions, the engine 9 will operate in low-range mode under very fuel-lean conditions with at least twice as much air than required for stoichiometric operation. The electronic control unit 13 will remain in low-range mode by monitoring the manifold absolute pressure sensor or the mass airflow sensor or throttle position sensor or any other load indicating sensor signals. However, as more power is required, the electronic control unit 13, using the signals from the throttle position sensor and knock sensor can be made to adaptively learn precisely when to switch to mid-range mode and prompt the start of natural gas addition to hydrogen. At the same time, the overall equivalence ratio begins to increase to a predetermined higher value that is still significantly below stoichiometric, so as to meet the power demand.

If the vehicle is equipped with an electronic throttle control or drive-by-wire control, the switch over from low-range mode to mid-range-mode to high-range mode will be seamless and transparent to the driver. The switch from low-range mode to mid-range mode can be prompted by the request for increased torque from the driver depressing the acceleration pedal 11. During passing and merging, when engine torque levels can be considered a safety issue, the electronic control unit 13 can again be made, either through the throttle position sensor and knock sensor feedback or by electronic throttle control, to smoothly and automatically switch over to high-range mode, which is predominantly natural gas operation at stoichiometric levels so that full torque is instantly available. At this point the electronic control unit 13, again based on signals indicating the engine load such as the intake mass air flow (manifold absolute pressure sensor or mass air flow sensor) or the oxygen level in the exhaust manifold 10 (exhaust gas O₂ sensor), maintains the overall fuel-air ratio at stoichiometric conditions, which permit a three-way catalytic convertor to simultaneously reduce emissions of carbon monoxide, unburned hydrocarbons, and oxides of nitrogen. The specific algorithms employed for these control operations may differ from that described above since it will depend on the complexity of the fuel delivery and engine system, and the type of engine sensing devices installed.

It is the timing and duration for which the control valves 5 and 6 are opened, that will determine the respective quantities of each gaseous fuel injected into the intake manifold 7 or engine cylinders of the engine 9 in each of the operating modes. The quantity of each fuel to be injected is determined by the needs of the driver, the operating conditions of the engine 9, and the operating strategy described above, and programmed into the electronic control unit. The depression of the accelerated 11 and the various sensors will send signals to the electronic control unit 13, which will in turn translate these signals in order to influence the timing of opening and the duration of opening of the valves 5 and 6. Moreover, as the acceleration pedal 11 is depressed fully, a load indicating sensor signal will indicate to the electronic control unit that the throttle valve 15 is at or nearly at a wide-open position which in turn will activate the high range, stoichiometric, predominantly natural gas mode.

In manual throttle systems the throttle position sensor by itself will not be a precise measurement of load, so the signals of the manifold absolute pressure sensor or of the mass air flow sensor may also be used to estimate the load. The knock sensor is another option in manual throttle systems that can be used to adaptively learn to control when to switch from one mode to the next. The electronic control unit 13 then monitors the accelerator pedal 11, again through the throttle position sensor or through the manifold absolute pressure sensor or mass air flow sensor estimates to determine whether the required load falls below a predetermined threshold level so that it may return to dual fuel-gas operation in the mid-range mode at a predetermined fuel-lean equivalence ratio. If the required load continues to decrease and eventually falls below another predetermined threshold level, the electronic control unit 13 will switch to low-range mode which is outright hydrogen operation at a predetermined low equivalence ratio. In all the above operating modes, the knock sensor may be monitored continuously to help control engine knock.

The fuel pressure sensor will also continuously monitor the fuel pressure in the hydrogen and natural gas supply lines in case one of the fuel source supplies have been exhausted or rendered inaccessible. In such a case, the fuel pressure sensor will prompt the electronic control unit 13 to switch into “limp home” mode. In the case that the natural gas supply 1 is exhausted or inaccessible, the electronic control unit 13 will switch to low-range mode and outright hydrogen operation under very fuel-lean condition with at least twice as much air than required for stoichiometric operation. Under “limp home” conditions with hydrogen operation, the electronic control unit 13 will not allow the engine 9 to switch out of the low-range mode to higher equivalence ratios irrespective of driver demands for increased torque. Similarly, in the case that the hydrogen-supply is exhausted or inaccessible, the fuel pressure sensor will prompt the electronic control unit 13 to switch to outright natural gas operation in both the mid-range and high-range mode.

Since the ignition characteristics and the flame propagation rates of natural gas and hydrogen are dissimilar, the electronic control unit 13 may also monitor variables such as the control mode of the engine, or in other words the relative proportion of the hydrogen and natural gas-components in the overall fuel mixture, as well as various operating conditions of the engine 9 and send a corresponding signal to the spark control module to determine the optimal spark ignition timing and spark-energy level.

While the invention has primarily been described above with references to a closed-loop, modern electronically fuel-injected spark-ignition engine, it should be understood that it is equally suited to provide efficient fuel control for a closed-loop carburetted engine, or an open-loop carburetted engine, or a fuel-injected engine with multipoint or multipoint sequential or bank-fire multipoint injection, or both closed-loop and open-looped engines with exhaust gas recirculation. The invention is also equally suited for engines with manual or automatic throttle systems, as well as vehicles equipped with electronic throttle control. Moreover, the invention is equally suited for stationary engines in which a fuel governor, instead of an accelerated pedal 11, is employed as a fuel quantity command device.

The methods of operating the engine can be selected for a corresponding brake mean effective pressure operation of the engine. The word “brake” denotes the actual torque/power available at the engine flywheel as measured on a dynamometer. The higher the brake mean effective pressure, the greater the torque and power output per unit of displacement. Thus, the brake mean effective pressure is a measure of the useful power output of the engine. The way of viewing the brake mean effective pressure is that it is the quantity of constant pressure that would have to exist in a cylinder during the power stroke in order to produce the same actual, or net power output at the flywheel. In other words, since the pressure within the cylinder during the power stroke varies considerably, if it were plotted against the crank angle, it would roughly be a half-parabolic shape, the mean or average pressure that would produce the same actual or net power output is called the brake mean effective pressure.

Operating regions of the system and method in accordance with the present invention are summarized in Table 1 presented herein below.

Operating Regions of the Hydrogen-Natural Gas Dual Fuel-Gas
Management System

| Operating | | | |
|---|---|---|---|
| Region | Eq. Ratio | Primary Fuel | Comments |
| Idle and Low | ≦0.5 | Hydrogen Only | Hydrogen is injected |
| Range | The values | | solely into the engine |
| | demarcating the | | to provide power dur- |
| | operating regions | | ing starting, idling and |
| | are estimates and | | at low loads. Lean |
| | may vary | | burn is maintained to |
| | depending on | | reduce NOₓ In a |
| | application. | | situation where the |
| | | | natural gas supply has |
| | | | been exhausted or |
| | | | rendered inaccessible, |
| | | | the vehicle will |
| | | | operate within this |
| | | | region so as to “limp |
| | | | home”. |
| Mid Range | 0.5-0.7 | Hydrogen and | Both hydrogen and |
| | The values | Natural Gas in | natural gas are injected |
| | demarcating the | Variable | into the engine in |
| | operating regions | Proportions | proportions dictated by |
| | are estimates and | | power output require- |
| | may vary | | ments. Lean burn is |
| | depending on | | maintained in this |
| | application. | | region to reduce NOₓ |
| | | | and increase thermal |
| | | | efficiency |
| High Range | 0.7-1.0 | Primarily | At high loads, mainly |
| | The values | Natural Gas | natural gas is injected |
| | demarcating the | | into the engine near or |
| | operating regions | | at stoichiometric |
| | are estimates and | | conditions in order to |
| | may vary | | provide full engine |
| | depending on | | torque. Hydrogen con- |
| | application. | | centration within this |
| | | | region may still be as |
| | | | high as 5%-10%. In a |
| | | | situation where the |
| | | | hydrogen supply has |
| | | | been exhausted or |
| | | | rendered inaccessible, |
| | | | the vehicle will “limp |
| | | | home” within this |
| | | | regime. |

The inventive method and system can also be applied to other fossil fuels and not limited only to natural gas and hydrogen. The other fossil fuels include gaseous fuels, such as methane, ethane, propane, as well as liquid fuels such as methanol, ethanol, and gasoline.

It will be understood that each of the elements described above, or two or more together, may also find a useful application in other types of constructions differing from the types described above.

While the invention has been illustrated and described as embodied in method of and system for fuel supply for an internal combustion engine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of a fuel supply for an internal combustion engine, comprising the steps of providing a first source of a first fluid fuel and a second source of a second fluid fuel which are separate from one another; sensing at least one operational parameter of an internal combustion engine; supplying natural gas from said first source and the second fuel from said second source in quantities which are determined in correspondence with the sensed operational parameter of the internal combustion engine; and mixing the first fuel and the second fuel in the quantities determined in correspondence with the sensed operational parameter so as to produce a fuel mixture to be supplied to the internal combustion engine.

2. A method as defined in claim 1, wherein said sensing of an operational parameter includes a sensing selected from the group consisting of sensing an engine coolant temperature, an intake air temperature, an engine speed, a throttle position, a manifold absolute pressure, a fuel pressure, a battery voltage, an exhaust gas O₂ composition, a knocking, a mass air flow, and an exhaust gas recirculation.

3. A method as defined in claim 1; and further comprising providing a fuel metering means for the first fuel located downstream of said first source and a fuel metering means for the second fuel provided downstream of said second source; receiving information about the sensed operational parameter by an electronic control unit; and controlling the valves by the electronic control unit so as to allow supplies of the first fuel and the second fuel from said sources through said valves in corresponding quantities.

4. A method as defined in claim 1; and further comprising regulating pressure of the first fuel and the second fuel downstream of the sources so as to provide mixing of the fuels with predetermined pressures.

5. A method as defined in claim 1; and further comprising supplying solely the first fuel which is hydrogen into the internal combustion engine during starting, idling and at low loads.

6. A method as defined in claim 1; and further comprising mainly supplying the second fuel which is natural gas into the internal combustion engine at high loads.

7. A method as defined in claim 1; and further comprising for operating the internal combustion engine over a full range of brake mean effective pressures from zero to a magnitude selected for maximum brake mean effective pressure operation of the internal combustion engine at a current operating speed of the internal combustion engine, controlling the supply of the first fuel which is hydrogen and the supply of the second fuel which is natural gas to meet the required brake mean effective pressure by varying an amount of hydrogen and natural gas flowing into the internal combustion engine per combustion cycle within a range extending at least from zero to 100% of the amount of hydrogen and natural gas flowing into the internal combustion engine per combustion cycle during operation of the internal combustion engine at maximum brake mean effective pressure for current operating speed of the internal combustion engine.

8. A method as defined in claim 1; and further comprising, for operating the internal combustion engine in a low range of brake mean effective pressure below a mid range and a high range of brake mean effective pressure, delivering solely the first fuel which is hydrogen into the internal combustion engine during cold starting and idling condition; delivering solely hydrogen in a low range of brake mean effective pressure while maintaining a mass air flow into the internal combustion engine approximately twice a quantity necessary for stoichiometric combustion; and selecting a low range of brake mean effective pressure from zero to a magnitude at which point delivery of the second fuel which is natural gas automatically commencing concurrently with hydrogen in corresponding proportions with a mass air flow no longer being at least twice the quantity necessary for stoichiometric combustion.

9. A method as defined in claim 1; and further comprising for operating the internal combustion engine in a mid range of brake mean effective pressure above a low range and below a high range, delivering concurrently both the first fuel which is hydrogen and the second fuel which is natural gas into the internal combustion engine in a mid range of brake mean effective pressure and in corresponding proportions while maintaining a mass air flow into the internal combustion engine significantly greater than a quantity necessary for stoichiometric combustion; and extending the mid range of brake mean effective pressure from a magnitude selected at which point natural gas delivery automatically commences concurrently with hydrogen to a magnitude selected at which point a mass air flow significantly greater than a quantity necessary for stoichiometric combustion is no longer maintained.

10. A method as defined in claim 1; and further comprising, for operating the internal combustion engine in a high range of brake mean effective pressure above a low range and a mid range of brake mean effective pressure minimizing a delivering of the first fuel which is hydrogen into the internal combustion engine so that the second fuel which is natural gas is predominantly utilized; extending the high range of brake mean effective pressure from a magnitude selected at which point hydrogen delivery is minimized to a magnitude selected for maximum brake mean effective pressure operation of the internal combustion engine at a current operating speed of the internal combustion engine; and delivering solely natural gas in the high range of brake mean effective pressure in corresponding quantities, while maintaining a mass air flow into the internal combustion engine at or near a quantity necessary for stoichiometric combustion.

11. A method as defined in claim 1; and further comprising, when of the second fuel which is natural gas has been exhausted or rendered inaccessible, delivering solely the first fuel which is hydrogen into the internal combustion engine in a low range of brake mean effective pressures and in corresponding quantities while maintaining a mass air flow into the internal combustion engine approximately twice a quantity necessary for stoichiometric combustion; and not permitting the internal combustion engine to extend past the low range of brake mean effective pressure irrespective of demands of a driver for increased brake mean effective pressure.

12. A method as defined in claim 1; and further comprising, for operating an internal combustion engine solely on the second fuel which is natural gas when supply of the first fuel which is hydrogen has been exhausted or rendered inaccessible, delivering solely natural gas into the internal combustion engine while maintaining a mass airflow into the internal combustion engine in a range between being significantly greater than a quantity necessary for stoichiometric combustion and a quantity necessary for stoichiometric combustion.

13. A system of a fuel supply for an internal combustion engine, comprising a first source of a first fluid fuel and a second source of a second fluid fuel which are separate from one another; means for sensing at least one operational parameter of an internal combustion engine; means for supplying the first fuel from said first source and the second fuel from said second source in quantities which are determined in correspondence with the sensed operational parameter of the internal combustion engine; and means for mixing the first fuel and the second fuel in the quantities determined in correspondence with the sensed operational parameter so as to produce a fuel mixture to be supplied to the internal combustion engine.

14. A system as defined in claim 13, wherein said sensing means includes a sensor selected from the group consisting of a sensor of an engine coolant temperature, a sensor of an intake air temperature, a sensor of an engine speed, a sensor of a throttle position, a sensor of a manifold absolute pressure, a sensor of a fuel pressure, a sensor of a battery voltage, a sensor of an exhaust gas O₂ concentration, a sensor of a knocking, a sensor of a mass air flow, and a sensor for exhaust gas recirculation.

15. A system as defined in claim 13; and further comprising a fuel metering means for the first fuel located downstream of said first source and a fuel metering means for the second fuel provided downstream of said second source of hydrogen; and an electronic control unit receiving information about the sensed operational parameter and controlling the valves so as to allow supplies of the first and second fuels from said sources through said valves in corresponding quantities.

16. A system as defined in claim 13; and further comprising means for regulating pressure of the first fuel and the second fuel downstream of the sources so as to provide mixing of the first and second fuels with predetermined pressures.

17. A system as defined in claim 13; and further comprising means for supplying solely the first fuel which is hydrogen into the internal combustion engine during starting, idling and at low loads.

18. A system as defined in claim 13; and further comprising means for supplying mainly the second fuel which is supplying natural gas into the internal combustion engine at high loads.

19. A system as defined in claim 13; and further comprising means for operating the internal combustion engine over a full range of brake mean effective pressures from zero to a magnitude selected for maximum brake mean effective pressure operation of the internal combustion engine at a current operating speed of the internal combustion engine, provide controlling the supply of the first fuel which is hydrogen and the supply of the second fuel which is natural gas to meet the required brake means effective pressure by varying an amount of hydrogen and natural gas flowing into the internal combustion engine per combustion cycle within a range extending at least from zero to 100% of the amount of hydrogen and natural gas flowing into the internal combustion engine per combustion cycle during operation of the internal combustion engine at maximum brake mean effective pressure for current operating speed of the internal combustion engine.

20. A system as defined in claim 13; and further comprising means which, for operating the internal combustion engine in a low range of brake mean effective pressure below a mid range and a high range of brake mean effective pressure, delivering solely the first fuel which is hydrogen into the internal combustion engine during cold starting and idling conditions; delivering solely hydrogen in a low range of brake mean effective pressure while maintaining a mass air flow into the internal combustion engine approximately twice a quantity necessary for stoichiometric combustion; and selecting a low range of brake mean effective pressure from zero to a magnitude at which point delivery of the second fuel or natural gas automatically commencing concurrently with hydrogen in corresponding proportions with a mass air flow no longer being at least twice the quantity necessary for stoichiometric combustion.

21. A system as defined in claim 13; and further comprising means which, for operating the internal combustion engine in a mid range of brake mean effective pressure above a low range and below a high range, provide delivering concurrently both the first fuel which is natural gas and the second fuel which is hydrogen into the internal combustion engine in a mid range of brake mean effective pressure and in corresponding proportions while maintaining a mass air flow into the internal combustion engine significantly greater than a quantity necessary for stoichiometric combustion; and extending the mid range of brake mean effective pressure from a magnitude selected at which point natural gas delivery automatically commences concurrently with hydrogen to a magnitude selected at which point a mass air flow significantly greater than a quantity necessary for stoichiometric combustion is no longer maintained.

22. A system as defined in claim 13; and further comprising means which, for operating the internal combustion engine in a high range of brake mean effective pressure above a low range and a mid range of brake mean effective pressure provide minimizing a delivery of the first fuel which is hydrogen into the internal combustion engine so that the second fuel which is natural gas is predominantly utilized; extending the high range of brake mean effective pressure from a magnitude selected at which point hydrogen delivery is minimized to a magnitude selected for maximum brake mean effective pressure operation of the internal combustion engine at a current operating speed of the internal combustion engine; and delivering solely natural gas in the high range of brake mean effective pressure in corresponding quantities, while maintaining a mass air flow into the internal combustion engine at or near a quantity necessary for stoichiometric combustion.

23. A system as defined in claim 13; and further comprising means which, when a supply of the second fuel which is natural gas has been exhausted or rendered inaccessible, provide delivering solely the first fuel which is hydrogen into the internal combustion engine in a low range of brake mean effective pressures and in corresponding quantities while maintaining a mass air flow into the internal combustion engine approximately twice a quantity necessary for stoichiometric combustion; and not permitting the internal combustion engine to extend past the low range of brake mean effective pressure irrespective of demands of a driver for increased brake mean effective pressure.

24. A system as defined in claim 13; and further comprising means which, for operating an internal combustion engine solely on the second fuel which is natural gas when supply of the first fuel which is hydrogen has been exhausted or rendered inaccessible, delivering solely natural gas into the internal combustion engine while maintaining a mass air flow into the internal combustion engine in a range between being significantly greater than a quantity necessary for stoichiometric combustion and a quantity necessary for stoichiometric combustion.
